(19) United States
(12) Patent Application Publication
(10) Pub. No.: US 2025/0144724 A1
(43) Pub. Date: May 8, 2025

(54) HEAT-REDUCING GROOVING TOOL HOLDERS

(71) Applicant: KENNAMETAL INDIA LIMITED, Bangalore (IN)

(72) Inventors: Ravi Halasur, Bangalore (IN); Igor Kaufmann, Fürth (DE); Padmakumar Muthuswamy, Bangalore (IN); Iranna Shidrameshetra, Bangalore (IN)

(21) Appl. No.: 18/502,553

(22) Filed: Nov. 6, 2023

(30) Foreign Application Priority Data
Nov. 2, 2022 (IN) 202241062580

(51) Int. Cl. B23C 3/30

(52) U.S. Cl. CPC B23C 3/30

(57) ABSTRACT

A grooving tool holder includes a lower portion, an upper portion, and a cutting insert receptacle. The upper portion is pivotable relative to the lower portion. The upper portion includes a rake face. The cutting insert receptacle is disposed between the lower portion and the upper portion. The cutting insert receptacle includes an upper clamping jaw disposed in the upper portion and a lower clamping jaw disposed in the lower portion. The cutting insert receptacle extends widthwise between opposed sidewalls of the lower portion and opposed sidewalls of the upper portion. The rake face is disposed adjacent to and over the cutting insert receptacle. The rake face extends between the opposed sidewalls of the upper portion. The rake face is disposed non-perpendicularly to the opposed sidewalls of the upper portion.

### FIELD OF THE DISCLOSURE

The disclosure relates to grooving tool holders and to methods of their use.

### BACKGROUND

Existing grooving tool holders often experience issues with the friction produced between the material cut by the grooving tool holder and the grooving tool holder. This friction may generate excessive heat resulting in deformation of the grooving tool holder. This may lead to grooving tool holder failure unless a substantially high coolant pressure is applied to reduce the heat.

An improved grooving tool holder and method of its use is needed to reduce one or more issues associated with one or more existing grooving tool holders.

### SUMMARY

In one embodiment, a grooving tool holder includes a lower portion, an upper portion, and a cutting insert receptacle. The upper portion is pivotable relative to the lower portion. The upper portion includes a rake face. The cutting insert receptacle is disposed between the lower portion and the upper portion. The cutting insert receptacle includes an upper clamping jaw disposed in the upper portion and a lower clamping jaw disposed in the lower portion. The cutting insert receptacle extends widthwise between opposed sidewalls of the lower portion and opposed sidewalls of the upper portion. The rake face is disposed adjacent to and over the cutting insert receptacle. The rake face extends between the opposed sidewalls of the upper portion. The rake face is disposed non-perpendicularly to the opposed sidewalls of the upper portion.

In another embodiment, a grooving tool holder includes a lower portion, an upper portion, a cutting insert receptacle, and a cutting insert. The upper portion is pivotable relative to the lower portion. The upper portion includes a rake face. The cutting insert receptacle is disposed between the lower portion and the upper portion. The cutting insert receptacle includes an upper clamping jaw disposed in the upper portion and a lower clamping jaw disposed in the lower portion. The cutting insert is disposed in the cutting insert receptacle. The rake face is disposed adjacent to and over the cutting insert. The rake face is shaped to direct material cut by the cutting insert to flow off the rake face laterally away from the rake face.

In still another embodiment, a method of cutting a groove in a workpiece is provided. In one step a grooving tool holder is fed towards a workpiece rotating relative to the grooving tool holder so that a cutting insert of the grooving tool holder contacts the workpiece. In another step, material of the workpiece is cut using the cutting insert to form the groove. In an additional step, the cut material is directed to flow off a rake face of the grooving tool holder laterally away from the rake face due to a shape of the rake face.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a perspective view of one embodiment of a grooving tool holder having a first rake face shape, and a cutting insert of the grooving tool holder cutting a groove in a workpiece;

FIG. 2 illustrates a partial top view of the embodiment of FIG. 1;

FIG. 3 illustrates a cross-section view along line 3-3 of the embodiment of FIG. 2;

FIG. 4 illustrates a partial, close-up view within circle 4-4 of the embodiment of FIG. 3;

FIG. 5 illustrates another partial, close-up view of a second rake face shape which may be substituted for the first rake face shape of the embodiment of FIGS. 1-4;

FIG. 6 illustrates another partial, close-up view of a third rake face shape which may be substituted for the first rake face shape of the embodiment of FIGS. 1-4;

FIG. 7 illustrates another partial, close-up view of a fourth rake face shape which may be substituted for the first rake face shape of the embodiment of FIGS. 1-4;

FIG. 8 illustrates another partial, close-up view of a fifth rake face shape which may be substituted for the first rake face shape of the embodiment of FIGS. 1-4;

FIG. 9 illustrates another partial, close-up view of a sixth rake face shape which may be substituted for the first rake face shape of the embodiment of FIGS. 1-4;

FIG. 10 illustrates another partial, close-up view of a seventh rake face shape which may be substituted for the first rake face shape of the embodiment of FIGS. 1-4;

FIG. 11 illustrates another partial, close-up view of an eighth rake face shape which may be substituted for the first rake face shape of the embodiment of FIGS. 1-4;

FIG. 12 illustrates another partial, close-up view of a ninth rake face shape which may be substituted for the first rake face shape of the embodiment of FIGS. 1-4; and

FIG. 13 is a flowchart illustrating one embodiment of a method of cutting a groove in a workpiece.

### DETAILED DESCRIPTION

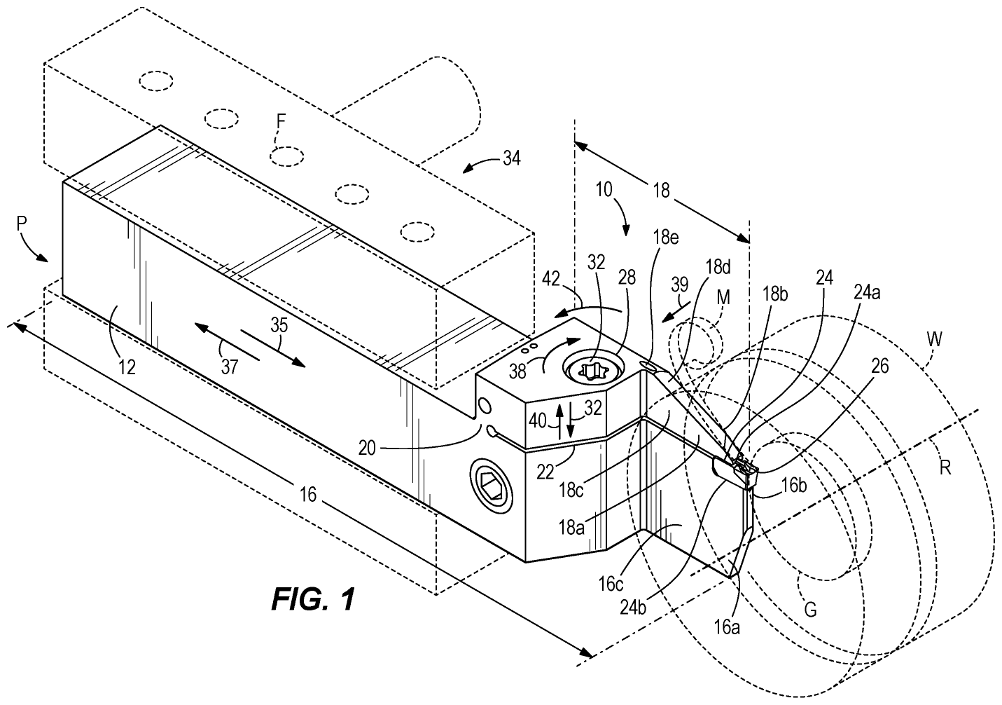

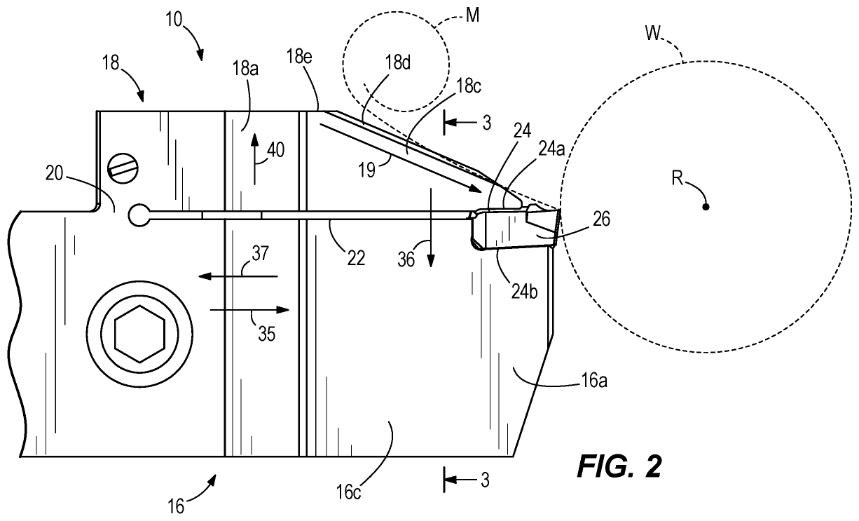

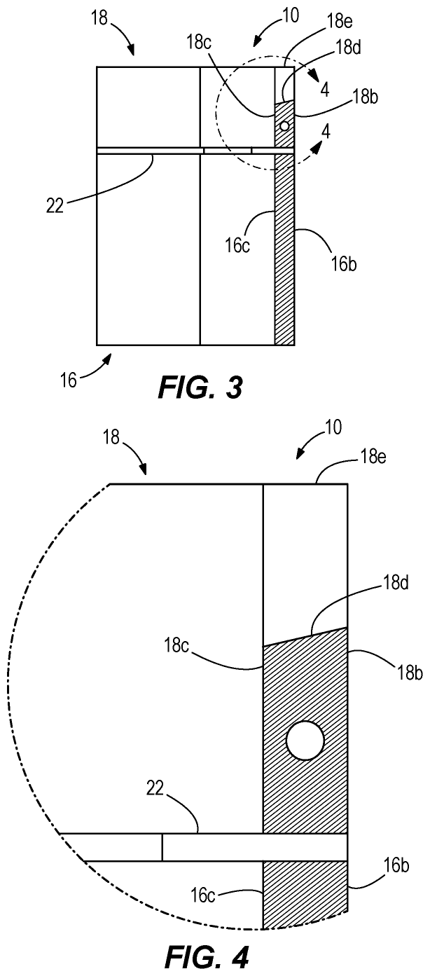

As shown in FIGS. 1-4 collectively, in one embodiment a grooving tool holder 10 comprises a shank 12, a lower portion 16, an upper portion 18, a web portion 20, a separating slit 22, a cutting insert receptacle 24, a cutting insert 26, a fastener-mating hole 28, and a fastener 32. The web portion 20 is disposed between the lower portion 16 and the upper portion 18. The separating slit 22 is disposed between the lower portion 16 and the upper portion 18. The separating slit 22 is disposed from the web portion 20 to the cutting insert receptacle 24. The upper portion 18 is pivotable relative to the lower portion 16 via the web portion 20.

The shank 12 extends longitudinally along the grooving tool holder 10. The shank 12 of the grooving tool holder 10 is clamped to a pocket P of a machine/tool adapter 34 using fasteners F.

The lower portion 16 comprises a first elongate member 16a extending longitudinally from the lower portion 16. The upper portion 18 comprises a second elongate member 18a extending longitudinally from the upper portion 18. The cutting insert receptacle 24 is disposed between the first elongate member 16a of the lower portion 16 and the second elongate member 18a of the upper portion 18. The cutting insert receptacle 24 comprises an upper clamping jaw 24a disposed in the second elongate member 18a of the upper portion 18 and a lower clamping jaw 24b disposed in the first elongate member 16a of the lower portion 16. The cutting insert receptacle 24 extends widthwise between opposed sidewalls 16b and 16c of the lower portion 16 and between opposed sidewalls 18b and 18c in the upper portion 18. The opposed sidewalls 16b and 16c and 18b and 18c are parallel to one another.

A rake face 18d of the second elongate member 18a of the upper portion 18 is disposed adjacent to and over the cutting insert receptacle 24. The rake face 18d extends longitudinally along direction 19 from a top surface 18e of the upper portion 18 to adjacent the cutting insert receptacle 24. The rake face 18d is disposed non-perpendicularly to the opposed sidewalls 18b and 18c of the upper portion 18. The rake face 18d extends linearly between the opposed sidewalls 18b and 18c of the upper portion 18 in a downward slope (slant) from opposed sidewall 18b to opposed sidewall 18c.

The cutting insert 26 is disposed between and against the upper clamping jaw 24a and the lower clamping jaw 24b. The upper clamping jaw 24a and the cutting insert 26 each comprise a separate respective mating V-shape that mate against one another. Similarly, the lower clamping jaw 24b and the cutting insert 26 each comprise a separate respective mating V-shape that mate against one another. The rake face 18d is disposed adjacent to and over the cutting insert 26.

The fastener-mating hole 28 extends through the upper portion 18 and the lower portion 16. The fastener 32 extends into the fastener-mating hole 28. The fastener 32 is threadedly attached to the fastener-mating hole 28 causing the cutting insert 26 to be clamped between the upper clamping jaw 24a and the lower clamping jaw 24b. The upper clamping jaw 24a is configured to move towards the lower clamping jaw 24b in direction 36 as the fastener 32 is rotated in direction 38 within the fastener-mating hole 28. As this happens, the upper clamping jaw 24a gradually clamps tighter against the cutting insert 26 providing continuously increasing clamping of the cutting insert 26 between the upper clamping jaw 24a and the lower clamping jaw 24b.

The upper clamping jaw 24a is configured to move away from the lower clamping jaw 24b in direction 40 as the fastener 32 is rotated in direction 42 within the fastener-mating hole 28. As this happens, the upper clamping jaw 24a gradually decreases the clamping against the cutting insert 26 providing continuously decreasing clamping of the cutting insert 26 between the upper clamping jaw 24a and the lower clamping jaw 24b. In one embodiment, direction 38 may be clockwise and direction 42 may be counter-clockwise. In other embodiments, directions 38 and 42 may vary.

With the opposed sidewalls 16b and 16c of the lower portion 16, the opposed sidewalls 18b and 18c of the upper portion 18, and the longitudinal direction 19 along which the rake face 18d extends each being disposed perpendicular to a rotation axis R around which a workpiece W rotates, the machine/tool adapter 34 may move the grooving tool holder 10 linearly in direction 35 towards the workpiece W to cut a groove G in the workpiece W with the cutting insert 26. Due to the rake face 18d extending linearly in a downward slope (slant) from opposed sidewall 18b to opposed sidewall 18c, the rake face 18d is shaped to direct material M cut by the cutting insert 26 to flow off the rake face 18d laterally in direction 39 away from the rake face 18. This results in material M cut by the cutting insert 26 to flow primarily towards opposed sidewall 18c of the grooving tool holder 10. This causes the material M cut by the cutting insert 26 to be diverted at an angle to the rake face 18. This reduces friction between the material M and the rake face 18. The deviated material M may hit the rotating workpiece W causing the deviated material M to break-up into shorter pieces. The shorter pieces of the deviated material M may have less contact with the grooving tool holder 10 resulting in less abrasion, less heat, and a longer life of the grooving tool holder 10. This results in the grooving tool holder 10 being able to work more efficiently with less coolant pressure being applied during the cutting of the material M. After the groove G is cut, the machine/tool adapter 34 may move the grooving tool holder 10 linearly in opposite direction 37 away from the workpiece W to retract the cutting insert 26 from the workpiece W.

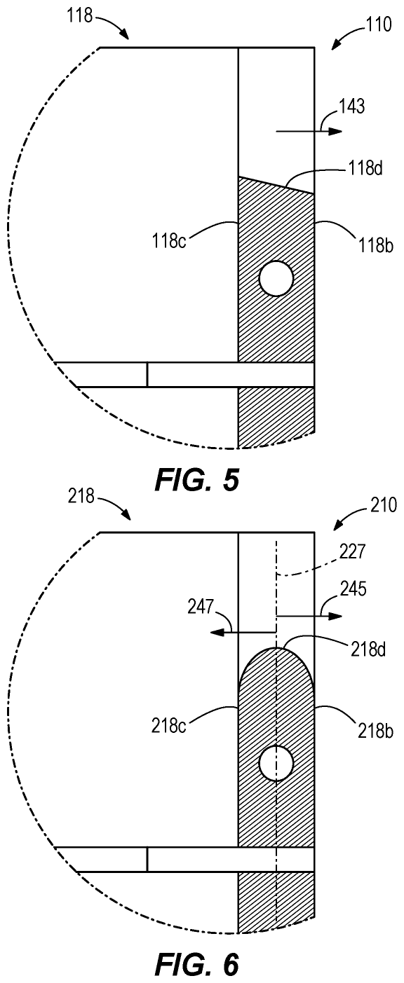

FIG. 5 illustrates another embodiment of a differently shaped rake face 118d which may be substituted for the rake face 18d of the grooving tool holder 10 of FIGS. 1-5. The rake face 118d extends linearly between the opposed sidewalls 118b and 118c of the upper portion 118 in a downward slope (slant) from opposed sidewall 118c to opposed sidewall 118b. Due to the rake face 118d extending linearly in a downward slope (slant) from opposed sidewall 118c to opposed sidewall 118b, the rake face 118d is shaped to direct material (not shown) cut by the cutting insert (not shown) to flow off the rake face 118d laterally in direction 143 away from the rake face 118d. This results in material cut by the cutting insert to flow primarily towards opposed sidewall 118b of the grooving tool holder 110. This causes the material cut by the cutting insert to be diverted at an angle to the rake face 118d. This reduces friction between the material and the rake face 118d. The deviated material may hit the rotating workpiece (not shown) causing the deviated material to break-up into shorter pieces. The shorter pieces of the deviated material may have less contact with the grooving tool holder 110 resulting in less abrasion, less heat, and a longer life of the grooving tool holder 110. This results in the grooving tool holder 110 being able to work more efficiently with less coolant pressure being applied during the cutting of the material.

FIG. 6 illustrates another embodiment of a differently shaped rake face 218d which may be substituted for the rake face 18d of the grooving tool holder 10 of FIGS. 1-5. The rake face 218d is curved in a semi-circular shape between the opposed sidewalls 218b and 218c of the upper portion 218. The rake face 218d is shaped to direct the material (not shown) cut by the cutting insert (not shown) off the rake face 218d laterally away from a longitudinal center axis 227 of the rake face 218d in direction 245 towards the opposed sidewall 218b and in direction 247 towards the opposed sidewall 218c of the upper portion 218. This causes the material cut by the cutting insert 226 to be diverted at an angle to the rake face 218d. This reduces friction between the material and the rake face 218d. The deviated material may hit the rotating workpiece (not shown) causing the deviated material to break-up into shorter pieces. The shorter pieces of the deviated material may have less contact with the grooving tool holder 210 resulting in less abrasion, less heat, and a longer life of the grooving tool holder 210. This results in the grooving tool holder 210 being able to work more efficiently with less coolant pressure being applied during the cutting of the material.

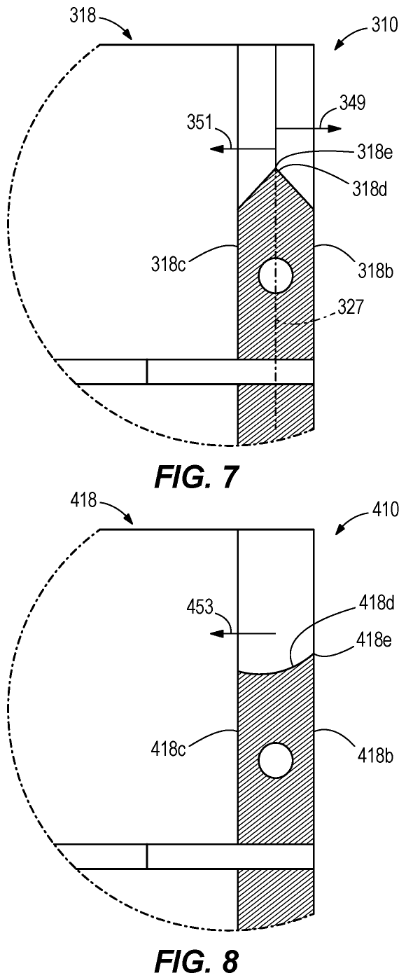

FIG. 7 illustrates another embodiment of a differently shaped rake face 318d which may be substituted for the rake face 18d of the grooving tool holder 10 of FIGS. 1-5. The rake face 318d is V-shaped between the opposed sidewalls 318b and 318c of the upper portion 318. The top 318e of the V-shape is disposed along the longitudinal center axis 327 of the rake face 318d. The V-shaped rake face 318d is shaped to direct material (not shown) cut by the cutting insert (not shown) to flow off the rake face 318d laterally away from the rake face 318d. This results in material (not shown) cut by the cutting insert (not shown) to flow from the longitudinal center axis 327 of the rake face 318d in direction 349 towards opposed sidewall 318b and in direction 351 towards opposed sidewall 318c of the grooving tool holder 310. This causes the material cut by the cutting insert to be diverted at angles to the rake face 318d. This reduces friction between the material and the rake face 318d. The deviated material may hit the rotating workpiece (not shown) causing the deviated material to break-up into shorter pieces. The shorter pieces of the deviated material may have less contact with the grooving tool holder 310 resulting in less abrasion, less heat, and a longer life of the grooving tool holder 310. This results in the grooving tool holder 310 being able to work more efficiently with less coolant pressure being applied during the cutting of the material.

FIG. 8 illustrates another embodiment of a differently shaped rake face 418d which may be substituted for the rake face 18d of the grooving tool holder 10 of FIGS. 1-5. The rake face 418d is curved in a concave shape between the opposed sidewalls 418b and 418c of the upper portion 418 with a highest point 418e of the rake face 418d being located on opposed sidewall 418b. The concave shape of the rake face 418d directs the material (not shown) cut by the cutting insert (not shown) off the rake face 418d laterally in direction 453 from opposed sidewall 418b towards opposed sidewall 418c. This causes the material cut by the cutting insert (not shown) to be diverted at an angle to the rake face 418d. This reduces friction between the material and the rake face 418d. The deviated material may hit the rotating workpiece (not shown) causing the deviated material to break-up into shorter pieces. The shorter pieces of the deviated material may have less contact with the grooving tool holder 410 resulting in less abrasion, less heat, and a longer life of the grooving tool holder 410. This results in the grooving tool holder 410 being able to work more efficiently with less coolant pressure being applied during the cutting of the material. In another embodiment, the highest point 418e of the concave-shaped rake face 418d may be located on opposed sidewall 418c directing the material cut by the cutting insert off the rake face 418d laterally from opposed sidewall 418c towards opposed sidewall 418b.

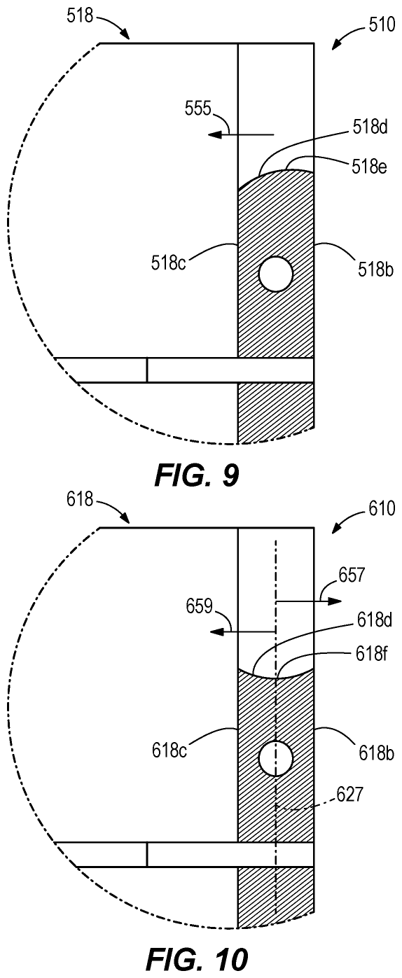

FIG. 9 illustrates another embodiment of a differently shaped rake face 518d which may be substituted for the rake face 18d of the grooving tool holder 10 of FIGS. 1-5. The rake face 518d is curved in a convex shape between the opposed sidewalls 518b and 518c of the upper portion 518 with a highest point 518e of the rake face 518d being located between opposed sidewall 518b and opposed sidewall 518c. The convex shape of the rake face 518d directs the material (not shown) cut by the cutting insert (not shown) off the rake face 518d laterally in direction 555 from opposed sidewall 518b towards opposed sidewall 518c. This causes the material cut by the cutting insert to be diverted at an angle to the rake face 518d. This reduces friction between the material and the rake face 518d. The deviated material may hit the rotating workpiece (not shown) causing the deviated material to break-up into shorter pieces. The shorter pieces of the deviated material may have less contact with the grooving tool holder 510 resulting in less abrasion, less heat, and a longer life of the grooving tool holder 510. This results in the grooving tool holder 510 being able to work more efficiently with less coolant pressure being applied during the cutting of the material. In another embodiment, the highest point 518e of the convex-shaped rake face 518d may be located in varying positions between the opposed sidewalls 518b and 518c directing the material cut by the cutting insert off the rake face 518d laterally towards either of opposed sidewalls 518b or 518c.

FIG. 10 illustrates another embodiment of a differently shaped rake face 618d which may be substituted for the rake face 18d of the grooving tool holder 10 of FIGS. 1-5. The rake face 618d is curved in a concave shape between the opposed sidewalls 618b and 618c of the upper portion 618 with a lowest point 618f of the rake face 618d being located on a longitudinal center axis 627 of the rake face 618d. The concave shape of the rake face 618d directs the material (not shown) cut by the cutting insert (not shown) off the rake face 618d laterally in direction 657 from longitudinal center axis 627 towards opposed sidewall 618b and in direction 659 from longitudinal center axis 627 towards opposed sidewall 618c. This causes the material cut by the cutting insert to be diverted at an angle to the rake face 618d. This reduces friction between the material and the rake face 618d. The deviated material may hit the rotating workpiece (not shown) causing the deviated material to break-up into shorter pieces. The shorter pieces of the deviated material may have less contact with the grooving tool holder 610 resulting in less abrasion, less heat, and a longer life of the grooving tool holder 610. This results in the grooving tool holder 610 being able to work more efficiently with less coolant pressure being applied during the cutting of the material.

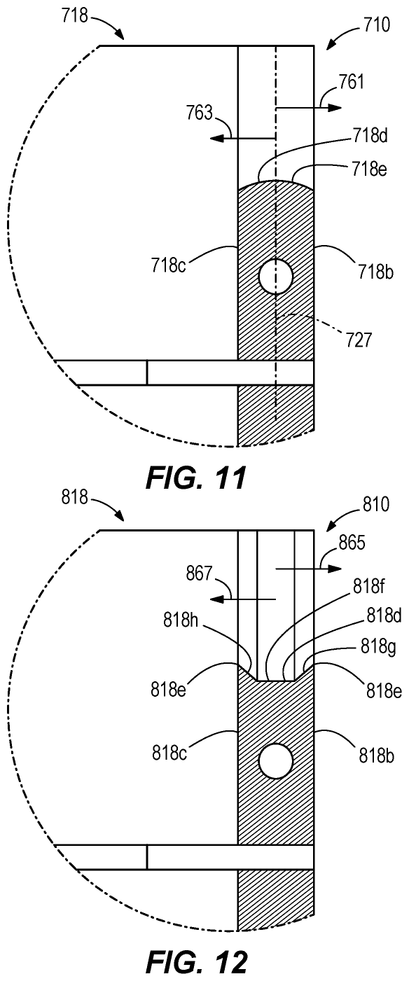

FIG. 11 illustrates another embodiment of a differently shaped rake face 718d which may be substituted for the rake face 18d of the grooving tool holder 10 of FIGS. 1-5. The rake face 718d is curved in a convex shape between the opposed sidewalls 718b and 718c of the upper portion 718 with a highest point 718e of the rake face 718d being located on a longitudinal center axis 727 of the rake face 718d. The convex shape of the rake face 718d directs the material (not shown) cut by the cutting insert (not shown) off the rake face 718d laterally in direction 761 from longitudinal center axis 727 towards opposed sidewall 718b and in direction 763 from longitudinal center axis 727 towards opposed sidewall 718c. This causes the material cut by the cutting insert to be diverted at an angle to the rake face 718d. This reduces friction between the material and the rake face 718d. The deviated material may hit the rotating workpiece (not shown) causing the deviated material to break-up into shorter pieces. The shorter pieces of the deviated material may have less contact with the grooving tool holder 710 resulting in less abrasion, less heat, and a longer life of the grooving tool holder 710. This results in the grooving tool holder 710 being able to work more efficiently with less coolant pressure being applied during the cutting of the material.

FIG. 12 illustrates another embodiment of a differently shaped rake face 818d which may be substituted for the rake face 18d of the grooving tool holder 10 of FIGS. 1-5. The rake face 818d is curved in a bowl shape between the opposed sidewalls 818b and 818c of the upper portion 818 with a bottom 818f of the bowl shape of the rake face 818d being located between the opposed sidewalls 818b and 818c and highest points 818e of the sides 818g and 818h of the bowl shape being located respectively on the opposed sidewalls 818b and 818c. The bowl shape of the rake face 818d directs the material (not shown) cut by the cutting insert (not shown) off the rake face 818d laterally in direction 865 from the bottom 818f of the bowl shape towards opposed sidewall 818b and in direction 867 from the bottom 818f of the bowl shape towards opposed sidewall 818c. This causes the material cut by the cutting insert to be diverted at an angle to the rake face 818d. This reduces friction between the material and the rake face 818d. The deviated material may hit the rotating workpiece (not shown) causing the deviated material to break-up into shorter pieces. The shorter pieces of the deviated material may have less contact with the grooving tool holder 810 resulting in less abrasion, less heat, and a longer life of the grooving tool holder 810. This results in the grooving tool holder 810 being able to work more efficiently with less coolant pressure being applied during the cutting of the material.

In other embodiments, one or more of the components of the grooving tool holders 10 of FIGS. 1-4 and the rake face 18d, 118d, 218d, 318d, 418d, 518d, 618d, 718d, and 818d of FIGS. 1-12 may not be present or may vary in type, form, configuration, shape, size, placement, location, or in other ways. The grooving tool holders 10, 110, 210, 310, 410, 510, 610, 710, and 810 and their associated planar or non-planar rake faces 18d, 118d, 218d, 318d, 418d, 518d, 618d, 718d, and 818d of FIGS. 1-12 may be manufactured using any conventional, non-conventional, or known method of manufacturing such as additive manufacturing, 3D manufacturing, or via other manufacturing methods.

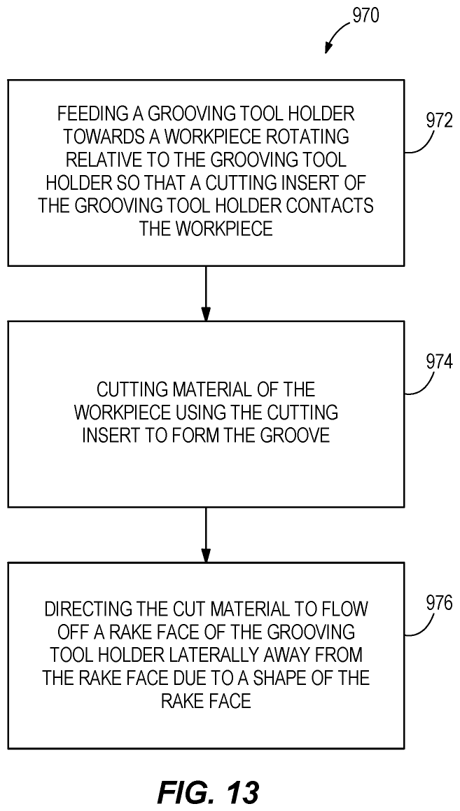

As shown in FIG. 13, one embodiment of a method 970 of cutting a groove in a workpiece is disclosed. The method 970 may utilize the grooving tool holder 10 of FIGS. 1-4 and any of the rake faces 18d, 118d, 218d, 318d, 418d, 518d, 618d, 718d, and 818d of FIGS. 1-12. In other embodiments, the method 970 may utilize varying grooving tool holders and/or rake faces. Step 972 comprises feeding a grooving tool holder towards a workpiece rotating relative to the grooving tool holder so that a cutting insert of the grooving tool holder contacts the workpiece. Step 974 comprises cutting material of the workpiece using the cutting insert to form the groove. Step 976 comprises directing the cut material to flow off a rake face of the grooving tool holder laterally away from the rake face due to a shape of the rake face.

In one embodiment, the directing the cut material to flow off the rake face of the grooving tool holder laterally away from the rake face in step 976 may comprise directing the cut material primarily towards a first sidewall of the grooving tool holder.

In one embodiment, the directing the cut material to flow off the rake face of the grooving tool holder laterally away from the rake face in step 976 may comprise directing the cut material away from a longitudinal center axis of the rake face.

In one embodiment, the directing the cut material to flow off the rake face of the grooving tool holder laterally away from the rake face in step 976 may comprise directing the cut material towards first and second sidewalls of the grooving tool holder.

In other embodiments, one or more steps of method 970 may be altered in substance and/or order, one or more steps may not be followed, or one or more additional steps may be added. In still other embodiments, the method 970 may further vary.

The method 970 may reduce one or more issues associated with existing methods of cutting a groove in a workpiece. The method 970 may result in material cut by the cutting insert to be diverted at an angle to the rake face. This may reduce friction between the material and the rake face. The deviated material may hit the rotating workpiece causing the deviated material to break-up into shorter pieces. The shorter pieces of the deviated material may have less contact with the grooving tool holder resulting in less abrasion, less heat, and a longer life of the grooving tool holder. This may result in the grooving tool body being able to work more efficiently with less coolant pressure being applied during the cutting of the material.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A grooving tool holder comprising:
a lower portion;
an upper portion pivotable relative to the lower portion, the upper portion comprising a rake face; and
a cutting insert receptacle disposed between the lower portion and the upper portion, the cutting insert receptacle comprising an upper clamping jaw disposed in the upper portion and a lower clamping jaw disposed in the lower portion, the cutting insert receptacle extending widthwise between opposed sidewalls of the lower portion and opposed sidewalls of the upper portion;
wherein the rake face is disposed adjacent to and over the cutting insert receptacle, the rake face extending between the opposed sidewalls of the upper portion, the rake face disposed non-perpendicularly to the opposed sidewalls of the upper portion.

2. The grooving tool holder of claim 1 wherein the rake face is linear.

3. The grooving tool holder of claim 1 wherein the rake face is curved.

4. The grooving tool holder of claim 1 wherein the rake face is concave.

5. The grooving tool holder of claim 1 wherein the rake face is convex.

6. The grooving tool holder of claim 1 wherein the rake face is semi-circular.

7. The grooving tool holder of claim 1 wherein the rake face is V-shaped.

8. The grooving tool holder of claim 1 wherein the rake face is bowl-shaped.

9. The grooving tool holder of claim 1 further comprising a cutting insert disposed in the cutting insert receptacle.

10. The grooving tool holder of claim 1 further comprising a web portion and a separating slit both disposed between the lower portion and the upper portion, the upper portion pivotable relative to the lower portion via the web portion, and the separating slit disposed from the web portion to the cutting insert receptacle.

11. A grooving tool holder comprising:
a lower portion;
an upper portion pivotable relative to the lower portion, the upper portion comprising a rake face;
a cutting insert receptacle disposed between the lower portion and the upper portion, the cutting insert receptacle comprising an upper clamping jaw disposed in the upper portion and a lower clamping jaw disposed in the lower portion; and
a cutting insert disposed in the cutting insert receptacle;
wherein the rake face is disposed adjacent to and over the cutting insert, the rake face shaped to direct material cut by the cutting insert to flow off the rake face laterally away from the rake face.

12. The grooving tool holder of claim 11 wherein the rake face is shaped to direct the material cut by the cutting insert primarily towards a first sidewall of the grooving tool holder.

13. The grooving tool holder of claim 11 wherein the rake face is shaped to direct the material cut by the cutting insert away from a longitudinal center axis of the rake face.

14. The grooving tool holder of claim 13 wherein the rake face is shaped to direct the material cut by the cutting insert towards first and second sidewalls of the grooving tool holder.

15. The grooving tool holder of claim 11 wherein the rake face is linearly slanted towards a first sidewall of the grooving tool holder.

16. The grooving tool holder of claim 11 wherein the rake face is curved.

17. A method of cutting a groove in a workpiece comprising:
feeding a grooving tool holder towards a workpiece rotating relative to the grooving tool holder so that a cutting insert of the grooving tool holder contacts the workpiece;
cutting material of the workpiece using the cutting insert to form the groove; and
directing the cut material to flow off a rake face of the grooving tool holder laterally away from the rake face due to a shape of the rake face.

18. The method of claim 17 wherein the directing the cut material to flow off the rake face of the grooving tool holder laterally away from the rake face comprises directing the cut material primarily towards a first sidewall of the grooving tool holder.

19. The method of claim 17 wherein the directing the cut material to flow off the rake face of the grooving tool holder laterally away from the rake face comprises directing the cut material away from a longitudinal center axis of the rake face.

20. The method of claim 19 wherein the directing the cut material to flow off the rake face of the grooving tool holder laterally away from the rake face comprises directing the cut material towards first and second sidewalls of the grooving tool holder.
